(19) United States
(12) Patent Application Publication
(10) Pub. No.: US 2003/0221025 A1
(43) Pub. Date: Nov. 27, 2003

(54) Circuit apparatus built in a computer peripheral device for detecting physiological signal

(75) Inventors: Chao-Fa Lee, Taipei (TW); Ya-Ting Lu, Taipei (TW); Kuo-Long Yang, Taipei (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei (TW)

(21) Appl. No.: 10/347,429

(22) Filed: Jan. 21, 2003

(30) Foreign Application Priority Data
May 27, 2002 (TW) 91207695

(51) Int. Cl. G06F 3/00

(52) U.S. Cl. 710/1

(57) ABSTRACT

A circuit apparatus built in a computer peripheral device for detecting physiological signal is disclosed, which has a signal detecting circuit to detect an optical signal from the environmental light source and sends the detected optical signal to a physiological signal processing circuit for performing digital process to obtain a physiological signal. Then, the physiological signal is sent to a computer via an input/output microprocessor circuit for showing the user's physiological state.

### BACKGROUND OF THE INVENTION

1. Field of the Invention

The present invention relates to a circuit for detecting physiological state and, more particularly, to a circuit apparatus built in a computer peripheral device for detecting physiological signal.

2. Description of Related Art

Due to the advance of the information technology and high-technique industry, people almost use the computer for working everyday. In addition, people widely use the windows operation system, and thus the mouse has become the necessary computer peripheral device. However, the computer workers always use the computers for a long time and in a high working pressure environment. They also sit in working and thus lacking exercise. Therefore, the computer workers are likely to have sickness with blood vessel, which may cause a sudden death.

As known, the doctors diagnose the physiological state of the sick man via measuring the number of the pulses. The number of the pulses usually is measured via out-of-body. Therefore, there is a demand on measuring the physiological state with the computer peripheral device for the computer workers.

### SUMMARY OF THE INVENTION

The first object of the present invention is to provide a circuit apparatus built in a computer peripheral device for detecting physiological signal, so as to conveniently measure the number of the human pluses.

The second object of the present invention is to provide a circuit apparatus built in a computer peripheral device for detecting physiological signal, so as to conveniently detect the environmental luminance.

To achieve the object, the circuit apparatus of the present invention comprises: a signal detecting circuit for sensing a body signal from detecting body surface, wherein the body signal passes through user's extremity operating the computer peripheral device and then received by the signal detecting circuit; a physiological signal processing circuit for processing the body signal that is received by the signal detecting circuit in order to generate a physiological signal; a controlling signal generating circuit for generating a controlling signal to control the computer peripheral device; and an input/output micro-processing circuit connected with the peripheral device to control the controlling signal or send the physiological signal to a computer, so that the computer displays the human physiological state based on the physiological signal.

Other objects, advantages, and novel features of the invention will become more apparent from the following detailed description when taken in conjunction with the accompanying drawings.

### BRIEF DESCRIPTION OF THE DRAWINGS

FIG. 1 is a functional block diagram according to the invention.

FIG. 2 is a block diagram of the optical processing circuit according to the invention.

FIG. 3 is a circuit diagram according to the invention.

### DETAILED DESCRIPTION OF THE PREFERRED EMBODIMENT

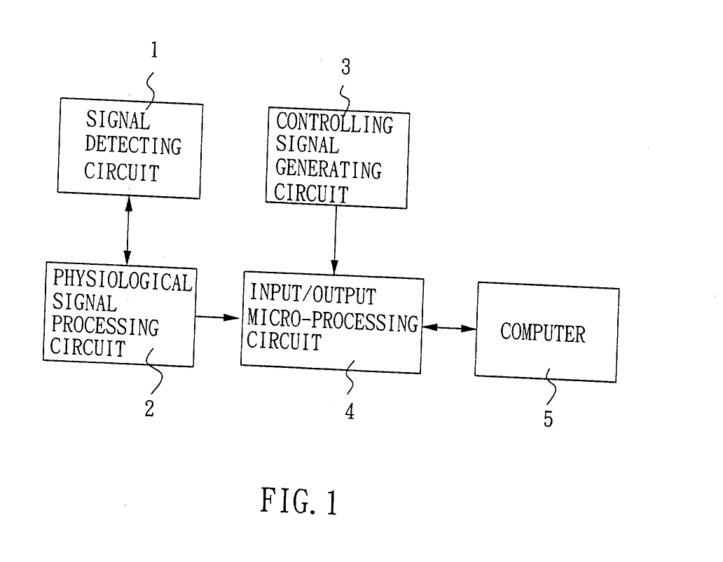

FIG. 1 is a functional block diagram of a preferred embodiment of the circuit apparatus built in a computer peripheral device for detecting physiological signal in accordance with the present invention. In this embodiment, a circuit built in a mouse is provided as an example for illustrative purpose. The circuit apparatus includes a signal detecting circuit 1, a physiological signal processing circuit 2, a controlling signal generating circuit 3 and an input/output micro-processing circuit 4, wherein the input/output micro-processing circuit 4 is connected to a computer 5.

In this preferred embodiment, the signal detecting circuit 1 senses the environmental light source or a specific light source in operating a computer. The optical sensor of the signal detecting circuit 1 is preferably positioned at the controlling button of the mouse, or any suitable position on the mouse. The signal detecting circuit 1 detects the environmental light source via the optical sensor. Namely, the light of the environmental light source passes through the user's finger operating the mouse and is detected by the optical sensor. The signal detecting circuit 1 sends the signal that is detected by the optical sensor to the physiological signal processing circuit 2 for digital signal processing.

The processed result of the physiological signal processing circuit 2 and the controlling signal generated by the controlling signal generating circuit 3 are processed by the input/output micro-processing circuit 4 for being transmitted to the computer 5. In this preferred embodiment, the input/output micro-processing circuit 4 is a universal serial bus (USB) micro-processing circuit, and the input/output micro-processing circuit 4 transmits the signal to the computer 5 via an USB cable.

In this preferred embodiment, the controlling signal generating circuit 3 further includes a standard mouse interface circuit, a windows scroll circuit and a controlling button circuit for generating a controlling signal for moving the cursor on the computer monitor or controlling at least one instruction that executes in the computer.

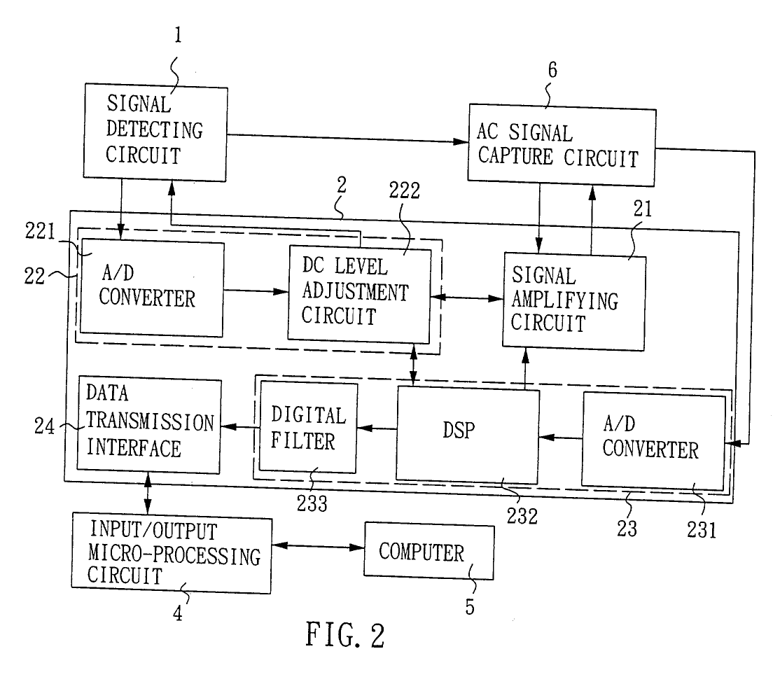

FIG. 2 shows a block diagram of the physiological signal processing circuit 2 of the present invention, which includes an AC signal amplifying circuit 21, a DC level capture and adjustment circuit 22, a digital signal processing and filtering circuit 23 and a data transmission interface 24. The DC level capture and adjustment circuit 22 further includes an analog/digital (A/D) converter 221 and a DC level adjustment circuit 222. The digital signal processing and filtering circuit 23 further includes an A/D converter 231, a digital processing processor (DSP) 232 and a digital filter 232. In this preferred embodiment, the digital filter 232 is an infinite impulse response (IIR) filter.

There is an AC signal capture circuit 6 between the physiological signal processing circuit 2 and the signal detecting circuit 1. The environmental light source signal that is detected by the signal detecting circuit 1 comprises the DC level optical signal and the AC level optical signal. The DC level optical signal needs to be processed by a low-pass-filter (LPF) process before being sent to the physiological signal processing circuit 2, and the AC level optical signal needs to be processed by a high-pass-filter (HPF) process before being sent to the physiological signal processing circuit 2.

The DC level optical signal is sent to the A/D converter 221 for being converted into a digital signal. Then, the digital signal is sent to the DSP 232 for digital processing via the DC level adjustment circuit 222 to obtain the environmental luminance. The DSP 232 adjusts the optical sensitivity of the signal detecting circuit 1 via the DC level adjustment circuit 222 based on the DC level optical signal that the DSP 232 received. Namely, the DSP 232 adjusts the impedance of the signal detecting circuit 1 to obtain a suitable impedance for sensing the environmental luminance.

The AC signal capture circuit 6 fetches the AC level optical signal, and then sends the AC level optical signal to the AC signal amplifying circuit 21 for performing an amplification process. The amplified AC level optical signal is sent to the A/D converter 231 via the AC signal capture circuit 6 for being converted into a digital signal. Then, the digital signal is sent to the DSP 232 for being processed to obtain a physiological signal that was passed through the user's finger (comprising the blood capillaries in the user finger). Because the environmental optical signal passing through the finger will generate a relative physiological signal due to the heartbeat, the physiological signal may represent the number of the user pluses,

The DSP 232 also adjusts the amplified gain of the AC signal amplifying circuit 21 based on the amplified AC optical signal that the DSP 232 received, so that the amplified AC optical signal is identified suitably for digital processing. The result (comprising the environment luminance and the number of the user pluses) that the DSP 232 processed is sent to the digital filter 233 for performing an IIR process. Thereby, the result that digital filter 233 processed is sent to the input/output micro-processing circuit 4 via the data transmission interface 24 for being sent to the computer 5.

The computer 5 installs relative application software to show the environment luminance for reminding the user to work at the best environment to protect the user's vision. The computer 5 also shows the number of the user pluses via the relative application software and records the number of the user pluses for determining the user's physiological state to remind the user to take care his/her physiological state.

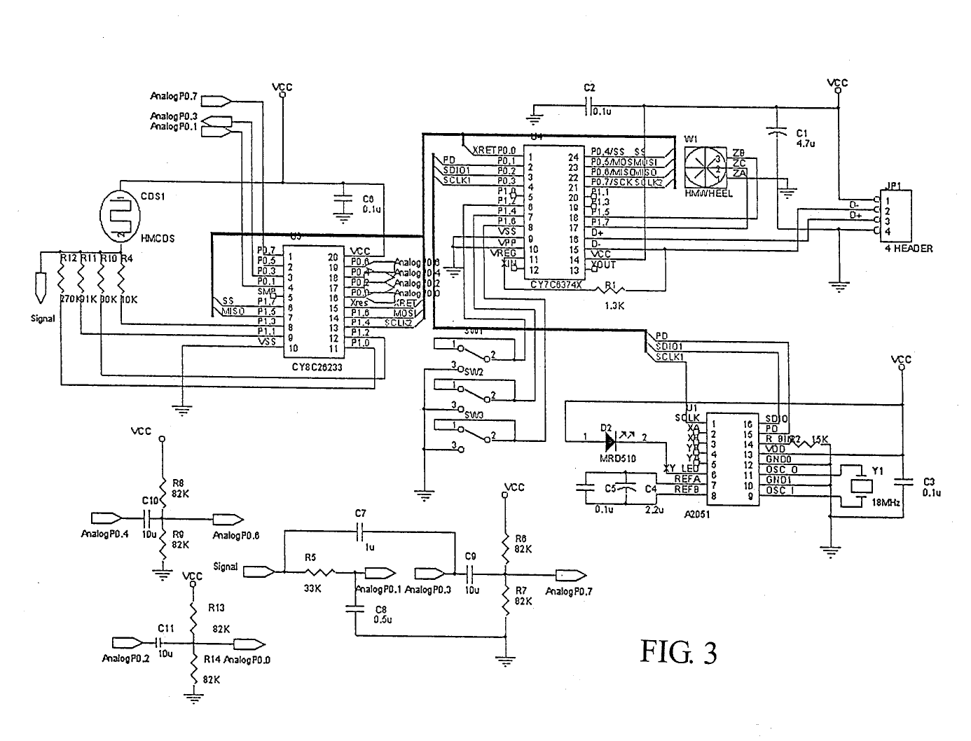

FIG. 3 shows the circuit diagram according to the invention. The signal detecting circuit 1 (with reference FIG. 1) is implemented by the photosensitive resistance CDS1. The physiological signal processing circuit 2 is implemented by the CY8C26233 chip. The controlling signal generating circuit 3 is implemented by the A2051 chip. The input/output micro-processing circuit 4 is implemented by the CY7C6347X chip. Besides, the signal detecting circuit 1, the physiological signal processing circuit 2, the controlling signal generating circuit 3 and the input/output micro-processing circuit 4 can be implemented by any equivalent circuits or compatible ICs.

In brief, the present invention utilizes a signal detecting circuit to detect the environmental light source, and sends the detected optical signal to a physiological signal processing circuit for performing a digital processing that includes low-pass filtering, high-pass filtering, DC level adjusting, AC amplified gain adjusting and digital filtering process. Then, the result that has been processed by the physiological signal processing circuit is sent to a computer via a USB microprocessor circuit for measuring the number of the user pluses and detecting the environmental luminance.

Although the present invention has been explained in relation to its preferred embodiment, it is to be understood that many other possible modifications and variations can be made without departing from the spirit and scope of the invention as hereinafter claimed.

What is claimed is:

1. A circuit apparatus built in a computer peripheral device for detecting physiological signal, comprising:
a signal detecting circuit for sensing a body signal from detecting body surface, wherein the body signal passes through user's extremity operating the computer peripheral device and then received by the signal detecting circuit;
a physiological signal processing circuit for processing the body signal that is received by the signal detecting circuit in order to generate a physiological signal;
a controlling signal generating circuit for generating a controlling signal to control the computer peripheral device; and
an input/output micro-processing circuit connected to a computer to control the controlling signal or send the physiological signal to the computer, so that the computer displays the human physiological state based on the physiological signal.

2. The circuit apparatus as claimed in claim 1, further comprising an AC signal capture circuit connected between the signal detecting circuit and the physiological signal processing circuit, so as to capture the AC signal of the body signal for being sent to the physiological signal processing circuit.

3. The circuit apparatus as claimed in claim 2, wherein the physiological signal processing circuit further includes an AC signal amplifying circuit, a DC level capture and adjustment circuit, a digital signal processing and filtering circuit and a data transmission interface, the AC signal amplifying circuit amplifying the AC signal captured by the AC signal capture circuit and sending the amplified AC signal to the digital signal processing and filtering circuit via the AC signal capture circuit for performing digital signal processing and digital filtering.

4. The circuit apparatus as claimed in claim 3, wherein the DC level capture and adjustment circuit captures the DC level signal of the optical signal, and then sends the DC level signal to the digital signal processing and filtering circuit for being processed, so that the digital signal processing and filtering circuit further adjusts the sensitivity of the signal detecting circuit based on the DC level signal.

5. The circuit apparatus as claimed in claim 3, wherein the data transmission interface transmits the result that the digital signal processing and filtering circuit processed to the input/output micro-processing circuit.

6. The circuit apparatus as claimed in claim 1, wherein the input/output micro-processing circuit is a universal serial bus (USB) micro-processing circuit, and the input/output micro-processing circuit transmits the signals to the computer via an USB cable.

7. The circuit apparatus as claimed in claim 1, wherein the controlling signal generating circuit further includes a sensing interface circuit, a standard mouse interface circuit, a windows scroll circuit and a controlling button circuit to move the cursor on the computer monitor or control at least one instruction executed in the computer.

8. The circuit apparatus as claimed in claim 1, wherein the physiological signal is human pulse.
